(19) United States
(12) Patent Application Publication
(10) Pub. No.: US 2017/0175326 A1
(43) Pub. Date: Jun. 22, 2017

(54) ASPHALTIC SUBSTRATES WITH TREATED GRANULES AND METHODS OF PREPARING THEREOF

(71) Applicant: FIRESTONE BUILDING PRODUCTS CO., LLC, Indianapolis, IN (US)

(72) Inventor: Wensheng ZHOU, Carmel, IN (US)

(73) Assignee: FIRESTONE BUILDING PRODUCTS CO., LLC, Indianapolis, IN (US)

(21) Appl. No.: 15/446,731

(22) Filed: Mar. 1, 2017

Related U.S. Application Data
(63) Continuation of application No. 13/958,969, filed on Aug. 5, 2013.
Application No. 13/958,969 is a continuation of application No. 13/045,167, filed on Mar. 10, 2011, now abandoned.
Application No. 13/045,167 is a continuation-in-part of application No. 13/022,395, filed on Feb. 7, 2011, now abandoned.
(60) Provisional application No. 61/312,464, filed on Mar. 10, 2010.
(60) Provisional application No. 61/301,918, filed on Feb. 5, 2010.
(60) Provisional application No. 61/312,464, filed on Mar. 10, 2010.

(51) Int. Cl. D06N 5/00; E04D 1/26; B05D 1/12

(52) U.S. Cl. CPC D06N 5/003; B05D 1/12; E04D 1/26; D06N 2201/082; D06N 2203/08; D06N 2203/066; D06N 2205/10; D06N 2209/0876; D06N 2211/06; D06N 2209/1692; E04D 2001/005

(57) ABSTRACT

A method for preparing a bituminous roofing article, the method comprising: (i) applying a fluorine-containing compound to a plurality of granules; (ii) depositing the plurality of granules on an asphaltic substrate; where the fluorine-containing compound is defined by the formula (V) or (VI):

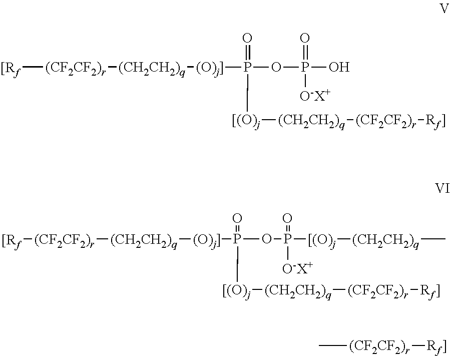

wherein r and q are independently integers of 1 to 3; R_{f} is linear or branched chain perfluoroalkyl group having 1 to 6 carbon atoms; j is an integer 0 or 1, or a mixture thereof, x is 1 or 2, X is hydrogen or M, and M is an ammonium ion, an alkali metal ion, or an alkanolammonium ion; and (iii) applying a silicone oil to the surface of the granules.

This application is a continuation of U.S. application Ser. No. 13/958,969 filed Aug. 5, 2013, which is a continuation of U.S. application Ser. No. 13/045,167 filed Mar. 10, 2011, which claims the benefit of U.S. Provisional Application Ser. No. 61/312,464 filed on Mar. 10, 2010, and U.S. application Ser. No. 13/022,395 filed Feb. 7, 2011, which claims the benefit of U.S. Provisional Application Ser. No. 61/301,918 filed on Feb. 5, 2010, and 61/312,464 filed on Mar. 10, 2010, all of which are incorporated herein by reference.

### FIELD OF THE INVENTION

Embodiments of the present invention are directed toward treated granules for use with roofing articles and roofing articles carrying the treated granules. In one or more embodiments, the granules are treated with a fluorine-containing compound.

### BACKGROUND OF THE INVENTION

Asphaltic roofing membranes, also known as bituminous membranes, have been employed to cover flat or low-sloped roofs. These membranes are typically installed by unrolling a roll of material on a roof surface and then heat seaming adjacent membranes together to form an impervious water barrier on the roof surface.

As part of the manufacturing process, the asphaltic roofing membranes are often coated with granular material. Among the benefits associated with the use of these granules is the ability to reflect solar radiation to thereby maintain a cooler roof surface. Other benefits include optional color, weatherability, and fire resistance.

Roofing granules or roofing articles may become discolored during manufacture, storage, or in use due to exposure to weather and natural elements including heat and rain. Also, the adhesion of the granules to the asphaltic substrate can be compromised either during manufacture of the membrane or during use on the roof surface where the granules absorb a deleterious amount of water. Likewise, dust generated by handling or other processing of the granules can cause manufacturing, installation, and overall problems in use.

Previously, silicone oils such as those described in U.S. Pat. Nos. 4,486,476, 4,452,961, 4,537,595, 4,781,950, 5,240,760, 5,362,566, and 5,484,477, have been used to promote adhesion of roofing granules to asphalt-based substrates and also have been reported to improve the stain resistance of the granules.

### SUMMARY OF THE INVENTION

One or more embodiments of the present invention provide a method for preparing a bituminous roofing article, the method comprising: (i) applying a fluorine-containing compound to a plurality of granules; (ii) depositing the plurality of granules on an asphaltic substrate; where the fluorine-containing compound is defined by the formula (V) or (VI):

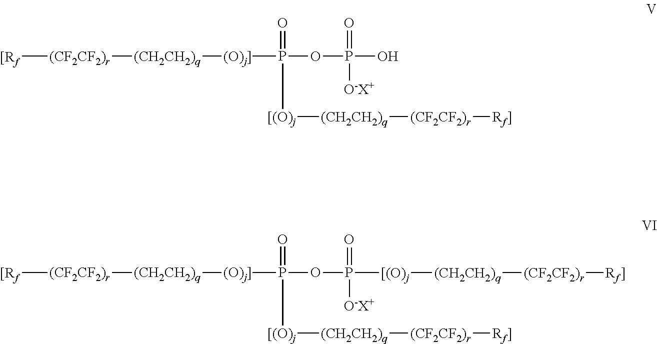

wherein r and q are independently integers of 1 to 3; R_{f} is linear or branched chain perfluoroalkyl group having 1 to 6 carbon atoms; j is an integer 0 or 1, or a mixture thereof, x is 1 or 2, X is hydrogen or M, and M is an ammonium ion, an alkali metal ion, or an alkanolammonium ion; and (iii) applying a silicone oil to the surface of the granules.

Other embodiments of the present invention provide a roofing article comprising: a bituminous substrate and reflective granules deposited on the substrate, where the granules include a fluorine-containing compound applied to the surface of the granules, where the fluorine-containing compound is compound is defined by the formula (V) or (VI):

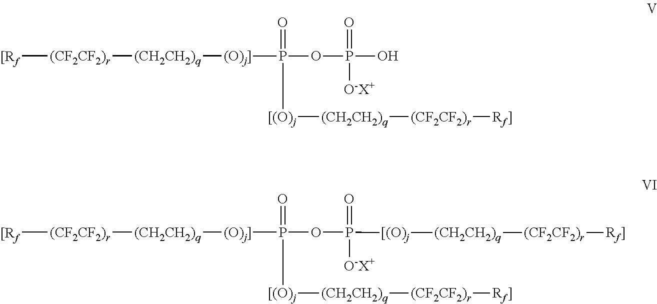

wherein r and q are independently integers of 1 to 3; R_{f} is linear or branched chain perfluoroalkyl group having 1 to 6 carbon atoms; j is an integer 0 or 1, or a mixture thereof, x is 1 or 2, X is hydrogen or M, and M is an ammonium ion, an alkali metal ion, or an alkanolammonium ion, and where the granules further include a silicone oil applied to the surface of the granules.

### DETAILED DESCRIPTION OF ILLUSTRATIVE EMBODIMENTS

It has been observed that granules used as a coating, or otherwise as a protective barrier, on asphaltic substrates (e.g. roofing membranes) can suffer from staining, poor water repellency, and/or poor adhesion to the substrate, which can lead to poor aesthetics and/or have a negative impact on solar reflectivity. For example, it is believed that constituents of the asphaltic substrate, onto which the reflective granules are applied, can migrate to granules and cause staining or discoloration. This problem is often observed during transportation and storage of the finished product, as well as use on the roof, especially at higher temperatures, which is believed to increase the rate of migration of certain asphaltic constituents. Also, the propensity of the granules to absorb water can lead to poor adhesion of granules to the substrate, which can cause manufacturing problems. The absorption of water can also be deleterious to longevity of the membrane and its ability to weather well. The invention is based, at least in part, on the discovery that granules treated with a fluorine-containing compound can overcome one or more of the observed problems. The granules are then applied to an asphaltic substrate to form a coating or protective barrier on the asphaltic substrate.

### Asphaltic Substrate

Practice of the present invention is not necessarily limited by the choice of asphaltic substrate, which may also be referred to as a bituminous membrane or asphaltic membrane. Any asphaltic substrate currently used in the roofing art can be used in practice of the present invention. In particular embodiments, the substrate includes a roofing shingle, which is conventionally used on residential buildings with relatively high-sloped roofs. In other embodiments, the asphaltic substrate includes modified asphalt membranes, which includes those membranes that are conventionally used on commercial buildings that have flat or low-sloped roofs. Examples of modified asphalt membranes are disclosed in U.S. Pat. Nos. 4,835,199, 4,992,315, 6,486,236, 6,492,439, 6,924,015, 7,070,843, 7,146,771, and 7,442,270, which are incorporated herein by reference.

In one or more embodiments, the asphaltic sheet includes a reinforcing fabric coated with an asphaltic-based composition. The fabric, or reinforcing sheet, may be woven or non-woven as is known in the art. Non-limiting examples of such fabric, also known as a scrim or fiberglass mesh sheet, include scrims that are commercially available. For example, fiberglass scrims are available under the trade name STYLE™ 930120 (Milliken & Co.; Spartanburg, S.C.) and also available from J. P. Stevens (Greenville, S.C.). In other embodiments, the reinforcing sheet may be an organic felt.

In one or more embodiments, asphaltic composition includes asphalt or bitumen, optionally polymer, and optionally other additives such as those conventionally employed in the art. Where a polymer is present in the composition, the asphaltic substrate may be referred as a polymer-modified membrane. The polymer modifier may be polymers or rubbers as known in the art. Non-limiting examples of such polymer modifiers include styrene butadiene rubber (SBR) or atactic polypropylene (APP).

### Granules

One or more embodiments of the invention are not limited by the type of granule that is treated. In particular embodiments, the granules exhibit a high degree of solar reflectance, and therefore the advantages associated with practice of this invention, such as stain-resistance, water repellency, and adhesion to the asphaltic substrate, are particularly beneficial to roofing membranes carrying granules that are highly reflective. In other embodiments, these advantages may be beneficial to other granules such as those colored granules used on residential roofing surfaces where aesthetics may be more important than solar reflectance.

In one or more embodiments, the granules include a base granule, which may also be referred to as a base rock. Optionally, the granules may be coated, whereby a coating at least partially covers the base rock. Examples of suitable coatings are disclosed in U.S. Pat. Nos. 4,359,505, 7,452,598, 7,641,959, and 8,361,597 and U.S. Publication Nos. 2006/0251807 and 2011/0052874, which are incorporated herein by reference. The terms ‘rocks’ or ‘granules’ may be used interchangeably. Furthermore, the terms ‘rocks’ or ‘granules’ may refer to uncoated or coated granules.

In one or more embodiments, the granules include highly reflective granules (e.g. those granules selected to provide a high degree of solar reflectance to roofing article). In other embodiments, the granules are colored or otherwise less reflective than highly reflective granules including those granules often used on residential roofing articles (e.g. shingles) such as those that colored or otherwise pigmented to provide aesthetic benefit.

In one or more embodiments, where the granules are highly reflective roofing granules, the granules may be characterized by a visible light (about 400 to about 700 nm) reflectivity of at least 70%, in other embodiments at least 75%, in other embodiments at least 80%, in other embodiments at least 85%, and in other embodiments at least 90%. In one or more embodiments, the granule are characterized by a UV electromagnetic radiation (about 10 nm to about 400 nm) reflectivity of at least 70%, in other embodiments at least 75%, in other embodiments at least 80%, in other embodiments at least 85%, and in other embodiments at least 90%. In one or more embodiments, the granules are characterized by an infrared electromagnetic radiation (about 700 nm to about 10⁻³ m) reflectivity of at least 70%, in other embodiments at least 75%, in other embodiments at least 80%, in other embodiments at least 85%, and in other embodiments at least 90%. In one or more embodiments, the granules are characterized by a terrestrial solar radiation (about 250 nm to about 2500 nm) reflectivity of at least 70%, in other embodiments at least 75%, in other embodiments at least 80%, in other embodiments at least 85%, and in other embodiments at least 90%. For purposes of this specification, terrestrial solar radiation refers to the solar radiation contacting sea level. In one or more embodiments, the bituminous substrates applied with granules of the invention are characterized by panel solar reflectance of at least 65%, in other embodiments at least 70%, in other embodiments at least 75%, in other embodiments at least 80%, in other embodiments at least 85%, and in other embodiments at least 90%.

In one or more embodiments, the granules are characterized as being chemically inert, which refers to the fact that the granules are stable to chemical conditions conventionally experienced on a roof surface. In one or more embodiments, the granules are insoluble in water, which refers to a solubility of 0.01 gram per liter or less at standard conditions of temperature and pressure and a pH of 7. In one or more embodiments, the granules are insoluble in water under acidic conditions, which refers to a solubility of 0.01 gram per liter or less at standard conditions of temperature and pressure and a pH of 5 or less, or in other embodiments at a pH of 4 or less, or in other embodiments at a pH of 3 or less, or in other embodiments at a pH of 2 or less. In these or other embodiments, the granules are insoluble in water under basic conditions, which refers to a solubility of 0.01 gram per liter or less at standard conditions of temperature and pressure and a pH of 8 or more, or in other embodiments at a pH of 9 or more, or in other embodiments at a pH of 10 or more, or in other embodiments at a pH of 11 or more.

In one or more embodiments, granules having a particular size are employed. The size of the granules, which may also be referred to as agglomerate size or as particle size, refers to largest axis (e.g., diameter of a spherical particle) of the granule, which may also be referred to as equivalent spherical diameter. In one or more embodiments, the granules are characterized by a size of from about −3½ to about +70 mesh, or in other embodiments from about −4 to about +35 mesh. In one or more embodiments, the particles, on average, are of sufficient size so that 90% or more of the material will pass through a 3½-mesh sieve (particles smaller than 5.66 mm) and be retained by a 70-mesh sieve (particles larger than 0.210 mm). In one or more embodiments, the size of the granules corresponds to full grade or No. 11 grade.

In one or more embodiments, the granules are characterized by an number average particle size of less than 10 mm, in other embodiments less than 3 mm, in other embodiments less than 1 mm, and in other embodiments less than 500 microns. In these or other embodiments, the granules are characterized by an average particle size of at least 10 μm, in other embodiments at least 100 μm, and in other embodiments at least 200 μm.

In one or more embodiments, the granules of the invention are naturally occurring materials such as talc, slag, granite, silica sand, greenstone, andesite, porphyry, marble, syenite, rhyolite, diabase, greystone, quartz, slate, trap rock, basalt, and marine shells can be used, as well as synthesized or processed ceramics or recycled manufactured materials such as crushed bricks, concrete, porcelain, sanitary ware, fire clay, refractories, proppants, and the like.

In one or more embodiments, the granules of the invention are ceramic materials, which include inorganic, non-metallic material that may include a crystalline phase, a non-crystalline phase (such as glass), or a combination of crystalline and non-crystalline phases.

In one or more embodiments, the granules of the invention are aluminosilicates. Aluminosilicates include compositions as known in the art according to the solid solution series in the binary system Al₂O₃—SiO₂. These compositions include, but are not limited to, alumina, mullite, cristobalite, quartz, amorphous silica, and combinations or mixtures thereof. In one or more embodiments, the granules of the invention include naturally derived aluminosilicates such as, but not limited to, kaolin. In one or more embodiments, the granules of the invention are kaolin or thermal derivatives thereof. In one or more embodiments, the granules are partially or fully calcined kaolin.

In one or more embodiments, the granules include calcined kaolin, which includes kaolin that has been converted from the corresponding (naturally occurring) hydrous kaolin to the dehydroxylated form by thermal methods. Calcination changes, among other properties, the kaolin structure from crystalline to a structure that may be crystalline, amorphous, or a combination thereof. Calcined kaolin of the invention may include mullite (Al₆Si₂O₁₃). Calcined kaolin of the invention may include amorphous silica, crystalline silica, or combinations thereof. Crystalline polymorphs of silica include cristobalite and quartz. Calcined kaolin of the invention may include additional crystalline or amorphous phases as a result of thermal treatment.

In one or more embodiments, calcination is effected by heat-treating hydrous kaolin as is known in the art, e.g. at temperatures ranging from about 500° C. to about 1500° C. or higher. In one or more embodiments, the calcined kaolin is thermally prepared at a calcination temperature of at least about 1000° C. and less than about 1400° C., or at least about 1050° C. and less than about 1350° C., or at least about 1100° C. and less than about 1300° C. Calcined or calcination as used herein may encompass any degree of calcination, including partial (meta) calcination, full calcination, flash calcination, or combinations thereof.

The degree to which hydrous kaolin undergoes changes in crystalline form can depend upon the amount of heat to which the hydrous kaolin is subjected. Initially, dehydroxylation of the hydrous kaolin can occur upon exposure to heat. At temperatures below a maximum of about 850 to 900° C., the product may be considered virtually dehydroxylated, with the resultant amorphous structure commonly referred to as a metakaolin. Frequently, calcination at this temperature is referred to ‘partial calcination’, and the product may also be referred to as ‘partially calcined kaolin’. Further heating to temperatures above about 900 to 950° C. can result in further structural changes, such as densification. Calcination at these higher temperatures is commonly referred to as ‘full calcination’, and the product is commonly referred to as ‘fully calcined kaolin’.

In one or more embodiments, the base rock is characterized by an aluminum oxide (Al₂O₃) content of less than 55%, in other embodiments less than 50%, and in other embodiments less than 45%. In these or other embodiments, the base rock is characterized by an aluminum oxide (Al₂O₃) content of at least 35%, in other embodiments at least 40%, and in other embodiments at least 42%. In these or other embodiments, the base rock is characterized by a silicon dioxide (SiO₂) content of less than 65%, in other embodiments less than 60%, and in other embodiments less than 55%. In these or other embodiments, the base rock is characterized by a silicon dioxide (SiO₂) content of at least 40%, in other embodiments at least 45%, and in other embodiments at least 49%. In one or more embodiments, the base rock is a refractory material sold under the name Mullite 45. In other embodiments, the base rock is crushed porcelain.

In other embodiments, the base rock is characterized by an aluminum oxide (Al₂O₃) content of less than 85%, in other embodiments less than 80%, and in other embodiments less than 75%. In these or other embodiments, the base rock is characterized by an aluminum oxide (Al₂O₃) content of at least 55%, in other embodiments at least 65%, and in other embodiments at least 70%. In these or other embodiments, the base rock is characterized by a silicon dioxide (SiO₂) content of less than 35%, in other embodiments less than 30%, and in other embodiments less than 27%. In these or other embodiments, the base rock is characterized by a silicon dioxide (SiO₂) content of at least 10%, in other embodiments at least 15%, and in other embodiments at least 20%. In one or more embodiments, the base rock is a refractory material sold under the name Mullite HM75 (GMRC).

In other embodiments, the base rock is crushed porcelain. In other embodiments, the base rock is calcium carbonate. In other embodiments, the base rock is alumina. In still other embodiments, the base rock is kaolin or calcined kaolin.

### Fluorine-Containing Compound

In one or more embodiments, the fluorine-containing compound is a fluorinated hydrocarbon or includes a fluorinated hydrocarbon substituent. As is known in the art, substituent refers to a portion of the overall molecule such as a pendent group or moiety. In one or more embodiments, the fluorinated hydrocarbon or substituent is at least 50%, in other embodiments at least 75%, and in other embodiments at least 90% fluorinated, which refers to placement of a fluorine atom where the hydrocarbon molecule or substituent would otherwise include a hydrogen atom bonded to a carbon atom. In one or more embodiments, the molecule or substituent is perfluorinated, which refers to a complete or substantially complete replacement by fluorine atoms of hydrogen atoms bonded to a carbon atom in the parent molecule or substituent.

In one or more embodiments, the fluorine-containing compounds used to treat the granules according to this invention include fluorine-containing surfactants. In one or more embodiments, these surfactants are characterized by including at least one hydrophobic substituent and at least one hydrophilic substituent. In one or more embodiments, the hydrophobic substituent is fluorinated. In one or more embodiments the hydrophilic substituent includes an ionic group.

In one or more embodiments, the fluorine-containing surfactant molecules are relatively small molecules. For example, the surfactant molecules may be characterized by a molecular weight of less than 5,000 g/mole, in other embodiments less than 2,500 g/mole, in other embodiments less than 1,000 g/mole, in other embodiments less than 750 g/mole, in other embodiments less than 500 g/mole, and in other embodiments less than 250 g/mole. In particular embodiments, these molecules have a molecular weight of from about 100 to 5,000 g/mole.

In particular embodiments, the fluorine-containing compound is a surfactant that includes a phosphorus atom within its hydrophilic portion or substituent. Examples of these compounds are disclosed in U.S. Pat. Nos. 3,083,224, 7,815,816, 7,674,928, 7,592,489, 7,470,818, 6,271,289, and 7,951,975, which are incorporated in their entirety herein by reference.

In one or more embodiments, the fluorine-containing compound may be defined by the formula (A):

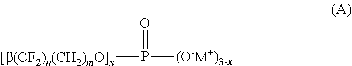

where β is hydrogen or fluorine, n is an integer from 2 to 4, m is an integer from 1 to 4, x is 1 or 2, M is hydrogen, alkali metal, ammonium, or substituted ammonium.

In one or more embodiments, the fluorine-containing compound may be defined by the formula (I) or (II):

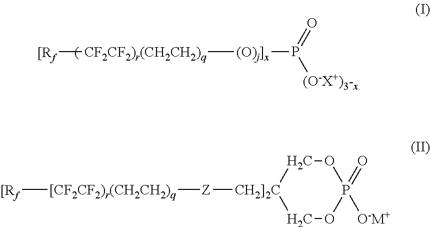

wherein r and q are independently integers of 1 to 3; R_{f} is linear or branched chain perfluoroalkyl group having 1 to 6 carbon atoms; j is an integer 0 or 1, or a mixture thereof, x is 1 or 2, Z is —O— or —S—, X is hydrogen or M, and M is an ammonium ion, an alkali metal ion, or an alkanolammonium ion.

In one or more embodiments, the fluorine-containing compound may be defined by the formula (III) or (IV):

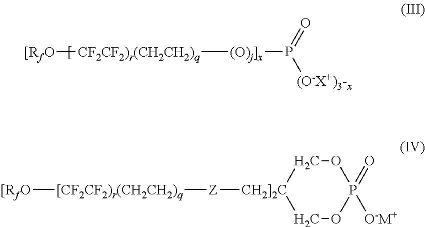

wherein r and q are independently integers of 1 to 3; R_{f} is linear or branched chain perfluoroalkyl group having 1 to 6 carbon atoms; j is an integer 0 or 1, or a mixture thereof, x is 1 or 2, Z is —O— or —S—, X is hydrogen or M, and M is an ammonium ion, an alkali metal ion, or an alkanolammonium ion.

In one or more embodiments, the fluorine-containing compound may be defined by the formula (V) or (VI):

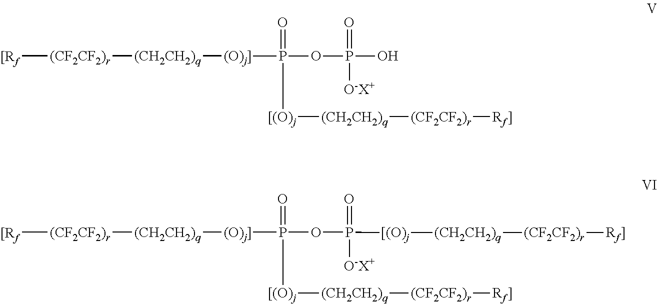

wherein r and q are independently integers of 1 to 3; R_{f} is linear or branched chain perfluoroalkyl group having 1 to 6 carbon atoms; j is an integer 0 or 1, or a mixture thereof, x is 1 or 2, X is hydrogen or M, and M is an ammonium ion, an alkali metal ion, or an alkanolammonium ion.

In specific embodiments, mixtures of fluorine-containing compounds are employed. For example, a mixture of compounds defined by the formula (I) together with a mixture of compounds defined by the formula (V) and (VI) may be employed.

It is believed that fluorine-containing surfactants of this embodiment are commercially available under the trade name CAPSTONE ST-300 (DuPont). Other non-limiting examples of useful fluorine-containing compounds are commercially available. For example, useful fluorine-containing compounds may be obtained under the trade names Capstone ST-100 (DuPont), SRC-220 (3M) and 6707W (Dow Corning).

In other embodiments, the fluorine-containing compounds may be polymeric species. In particular embodiments, the polymeric species is a block copolymer including at least one block that contains one or more fluorine-containing substituents and at least one block that contains a fluorine-free substituent, or that is substantially free of fluorine. In one or more embodiments, the block that is free or substantially free of fluorine may be a poly(alkylene oxide) block such as poly(ethylene oxide) or poly(propylene oxide) block.

### Method for Treating Granules

In one or more embodiments, the granules are treated with the fluorine-containing compound by contacting the granules and the fluorine-containing compound with each other. In one or more embodiments, the step of treating the granules occurs prior to application of the granules to the asphaltic substrate.

In one or more embodiments, the fluorine-containing compound may be contacted with the granules together with a carrier, or in other embodiments, the fluorine-containing compound is applied to the granules in a neat form. For example, the carrier may include an organic solvent or water and therefore a solution, dispersion, latex, or emulsification of fluorine-containing compound in water or solvent is applied to the granules. In one or more embodiments, the carrier (e.g., organic solvent or water) is removed from the granules by, for example, evaporation of the carrier. In other embodiments, the carrier is likewise deposited and remains (e.g. for a relatively long time such as beyond drying) on the granule; for example, the carrier may include an oil such as a silicone oil. In one or more embodiments, the neat form of the fluorine-containing compound may be in the form of a solid or a liquid.

In one or more embodiments, the carrier may include a liquid in which the fluorine-containing compound is dispersed. In other embodiments, the carrier may be a liquid in which the fluorine-containing compound is dissolved or partially dissolved.

In one or more embodiments, the step of treating the granules with fluorine-containing compound results in the granules carrying, on a solids weight basis, at least 0.01 parts, in other embodiments at least 0.05 parts, in other embodiments at least 0.08 parts, in other embodiments at least 0.1 parts, in other embodiments at least 0.3 parts, in other embodiments at least 0.5 parts, in other embodiments at least 0.8 parts, and in other embodiments at least 1.0 part fluorine-containing compound per 1000 grams of granule. In these or other embodiments, the step of treating the granules with fluorine-containing compound results in the granules carrying, on a solids weight basis, less than 50 parts, in other embodiments less than 30 parts, in other embodiments less than 20 parts, in other embodiments less than 10 parts, in other embodiments less than 5 parts, and in other embodiments less than 2 parts fluorine-containing compound per 1000 grams of granules.

In one or more embodiments, the fluorine-containing compounds are applied to the granules in the form an aqueous dispersion. In one or more embodiments, the solids content (e.g. fluorine-containing compound) of the dispersion may be at least 1 wt %, in other embodiments at least 3 wt %, in other embodiments at least 5 wt %, in other embodiments at least 10 wt %, in other embodiments at least 15 wt %, and in other embodiments at least 20 wt %. In these or other embodiments, the solids content of the dispersion may be less than 50 wt %, in other embodiments less than 35 wt %, in other embodiments less than 30 wt %, and in other embodiments less than 25 wt %.

In one or more embodiments, the fluorine-containing compound is applied to the granules in the form of an aqueous dispersion, and the amount of the aqueous dispersion is sufficient to provide an advantageous coating to the granules. In one or more embodiments, treatment of the granules includes, on a weight basis, an application of at least 10 parts, in other embodiments at least 30 parts, in other embodiments at least 40 parts, and in other embodiments at least 45 parts of the aqueous dispersion per 1000 parts of granules. In these or other embodiments, treatment of the granules includes, on a weight basis, an application of less than 250 parts, in other embodiments less than 100 parts, in other embodiments less than 80 parts, in other embodiments less than 70 parts, and in other embodiments less than 55 parts of the aqueous dispersion per 1000 parts of granules.

As noted above, the treatment step may take place by contacting the granules with the fluorine-containing compound. This method may include contacting the granules with the fluorine-containing compound prior to depositing the granules on the asphaltic substrate. For example, the granules can be placed into an appropriate vessel that may provide for agitation of the granules. The silicone oil can be added to the vessel before or after the introduction of the granules, and mixing or agitation may be accomplished by employing known methods. After treatment with the silicone oil, which may include mixing and sufficient time ensure adequate coating or adsorption, the fluorine-containing compound (e.g. in the form of a latex or solution), may then be added to the vessel. The granules may undergo further mixing and time may be provided to ensure sufficient absorption or coating of the granules.

In one or more embodiments, the fluorine-containing compound may be introduced to the vessel by spraying. Although practice of the present invention is not limited by the manner in which the granules are treated. Other continuous methods of treatment are contemplated; such as those employed in the art of treating granular materials such as fertilizers and the like. As is known in the art, these methods may employ one or more mixing augers together with elements to deliver liquids to the granules undergoing mixing by the augers. Or, it is contemplated that the treatment step may take place in continuous kilns such as those commonly employed in the color or pigmentation of granules conventionally applied to residential roofing shingles.

In any event, the granules can be removed from the mixing vessel or apparatus and dried by employing known techniques. For example, the granules can be exposed to hot air while undergoing mixing or other agitation to provide sufficient heat and air flow through the granules to achieve sufficient drying. In one or more embodiments, the granules are dried to an extent that they include less than 5 wt %, in other embodiments less than 2 wt %, in other embodiments less than 1 wt %, in other embodiments less and 0.5 wt %, and in other embodiments less than 0.25 wt % water, based on the entire weight of the granule. As is known in the art, the weight percentage of water within or associated with the granules may be determined employing standard techniques using moisture analyzers as known in the art. For example, moisture content may be determined using electronic moisture analyzer Sartorius MA-30 (Sartorius) running at a test temperature of 130° C.

In other embodiments, the granules can be treated after the granules are deposited on the asphaltic substrate.

Treatment with Silicone Oil

In one or more embodiments, the granules may optionally also be treated by contacting them with a silicone oil. In one or more embodiments, the granules are treated with the silicone oil and then subsequently treated with the fluorine-containing compound. In other embodiments, the granules can be simultaneously treated with the silicone oil and the fluorine-containing compound. In other embodiments, the granules are treated with the fluorine-containing compound and then subsequently treated with the silicone oil.

In one or more embodiments, the initial treatment with the silicone oil unexpectedly facilitates and improves the step of treating the granules with the fluorine-containing compound and therefore particular embodiments are directed to the treatment with silicone oil prior to or together with the treatment with the fluorine-compound. Also, treatment with the silicone oil has been found to alleviate dust issues that can hinder processing and installation of the membranes.

In one or more embodiments, the silicone oil is contacted with the granules in its neat form. In other embodiments, silicone oil is contacted with the granules together with a carrier. In one or more embodiment, the carrier may be a solvent or water and therefore a solution, dispersion, latex or emulsification of silicone oil in water or solvent is applied to the granules. In other embodiments, the carrier is likewise deposited and remains (e.g. for a relatively long time such as beyond drying) on the granule; for example, the carrier may include another oil such as a hydrocarbon oil. Useful hydrocarbon oils are commercially available. For example, useful hydrocarbon oils may be obtained under the trade names L500 and B300 (Cross Oil), 600HC (Flint Hills), or Plus-70T (STE Oil). In one or more embodiments, the neat form of the silicone oil may be in the form of a solid or a liquid.

In one or more embodiments, the silicone oils include polysiloxanes. These polysiloxanes, which may also be referred to as siloxanes, may include pendent hydrocarbyl groups such as alkyl (e.g. methyl and butyl) and aryl (e.g. phenyl) groups. In one or more embodiments, the siloxanes may include pendent functional groups, which may include organic groups including one or more heteroatoms such as oxygen or nitrogen. Exemplary functional groups include alkoxy group (e.g. methoxy and ethoxy groups), epoxide groups (e.g. ethylene and propylene oxide groups), amine groups, and carboxyl groups. In particular embodiments, the siloxane may include a methylethoxy polysiloxane.

Useful silicone oils include those described in U.S. Pat. Nos. 4,631,207, 4,810,748, 4,870,130, 4,876,152, 4,978,706, 5,080,824, 5,240,760, 5,362,566, 5,434,198, 5,484,477, 6,054,221, 6,294,608, 6,545,104, 7,026,013, and 7,141,303, which are all incorporated herein by reference.

Useful silicone oils are commercially available. For example, useful silicone oils may be obtained under the trade names Xiameter (Dow Corning), Rhodorsil BP (Rhodia), MineralSeal (Silicon Derivatives), Tegosivin HL 100 (Evonik Industries), Tegopren 6814 (Evonik Industries), SF-96-50 (General Electric), Niax L-5150 (General Electric), Silbyk-TP 3806 (BYK Chemie), and Pel-Sil 9920 (Pelron). Further, useful emulsified silicone oils are commercially available. For example, useful emulsified silicone oils may be obtained from Evonik Industries under the trade names Sitren 595, HE 328, HE 899 or from Dow Corning under the trade names Z70, IE 6694, and 1-6184.

In one or more embodiments, the step of treating the granules with silicone oil results in the granules carrying, on a solids weight basis (including neat liquid), at least 0.002%, in other embodiments at least 0.008%, in other embodiments at least 0.03%, in other embodiments at least 0.05%, in other embodiments at least 0.10%, in other embodiments at least 0.15%, in other embodiments at least 0.18% and in other embodiments at least 0.2% silicone oil, based upon the total weight of the granules. In these or other embodiments, the step of treating the granules with silicone oil results in the granules carrying, on a solids weight basis, less than 3.0%, in other embodiments less than 1.8%, in other embodiments less than 0.8%, in other embodiments less than 0.5%, in other embodiments less than 0.3%, and in other embodiments less than 0.25% silicone oil, based upon the total weight of the treated granule.

### Method of Preparing Coated Membrane

In one or more embodiments, the roofing articles of the present invention are prepared in the manner known in the art. For example, a plurality of granules is applied by dropping them onto a planar surface of a bituminous substrate. The granules of the invention may additionally be applied to the substrate in subsequent or multiple drops as is known in the art.

In one or more embodiments, the granules may be heated prior to being deposited on to the substrate. Also, the substrate may be heated or the asphaltic component of the substrate may be in a molten state. In one or more embodiments, the temperature of the granules and/or the temperature of the substrate are at least about 150° C. and less than about 230° C., or at least about 160° C. and less than about 190° C., or at least about 170° C. and less than about 180° C.

In alternative embodiments, one or more of the treatments contemplated by this invention (i.e., the silicone oil or fluorine-containing compound treatment) may take place after the granules are deposited on to the asphaltic substrate. For example, in one or more embodiments, both the silicone oil and the fluorine-containing compound may be sprayed or otherwise applied to the granules after the granules have been deposited on the asphaltic substrate. In other embodiments, the treatments may be bifurcated. For example, the silicone oil treatment may occur prior to depositing the granules on the substrate and the fluorine-containing compound may be applied to the granules after the granules are applied to the substrate.

In one or more embodiments, the asphaltic or bituminous product of this invention is characterized by exhibiting a solar reflectance, as defined and determined by the EnergyStar rating or California Title 24 (Cool Roof Rating Council test CRRC-1 in conjunction with ASTM C1549), which reflectance may be referred to as panel reflectance, of at least 30%, in other embodiments at least 40%, in other embodiments at least 50%, in other embodiments at least 60%, in other embodiments at least 65%, in other embodiments at least 70%, in other embodiments at least 72%, and in other embodiments at least 75% reflectivity.

In one or more embodiments, the granules as applied to the bituminous substrate are characterized by a surface coverage on the first planar surface of at least 85%, in other embodiments at least 90%, in other embodiments at least about 95%, or at least about 96%, or at least about 97%, or at least about 98%, or at least about 98.5% or at least about 99%, or at least about 99.5%. In one of more embodiments, surface coverage is determined optically by image analysis as is known in the art.

In order to demonstrate the practice of the present invention, the following examples have been prepared and tested. The examples should not, however, be viewed as limiting the scope of the invention. The claims will serve to define the invention.

### EXAMPLES

Various commercially available chemicals were tested for suitability for treating granules to achieve stain resistance as contemplated by this invention. The granules that were treated were calcined kaolin prepared as described in copending PCT/US11/20044, which is incorporated herein by reference.

1,000 g samples were prepared by treating the granules with the various materials set forth in Table 1. Unless otherwise noted, treatment chemical was applied neat. The granules were completely coated by pouring the treatment material over the granules and mixing thoroughly in paint shaker. The treated granules were then deposited onto neat hot asphalt contained in canister to completely cover the asphalt surface while maintaining at least one monolayer of granules left exposed at top surface and embedded only about half way into the asphalt. The granules/asphalt samples were then placed in an oven at 80° C. for 120 hours. Visual rankings, as recorded in Table I, were then assigned as compared to control sample.

The following grading scale was used to rate the chemicals visually according to staining observed under set conditions wherein grade 1 is excellent (no staining observed) and grade 5 is poor (heavily stained):

1=no staining;

2=very little staining, difficult to notice;

3=little staining, noticeable;

4=some staining, more noticeable;

5=stained heavily; almost no white visible.

TABLE 1

| | | | | Treatment | |
|---|---|---|---|---|---|
| | | | | Applied | Stain |
| | | | General | (per 1000 g | Resistance |
| Sample # | Trade Name | Manufacturer | Description | granules) | (Rank) |
| 1 | HL100/8614 | Evonik | methylethoxy | 0.12-3 g each | 5 |
| | | | polysiloxane/ | of HL100 & | |
| | | | arkyl | 8614 | |
| | | | polydimethylsiloxane | in 4-20 g oil | |
| | | | | (L500) | |
| 2a | HL100 | Evonik | methylethoxy | 5 g | 5 |
| 2b | | | polysiloxane | 20 g | 5 |
| 2c | | | | 100 g | 4 |
| 3a | 8614 | Evonik | arkyl | 20 g | 5 |
| 3b | | | polydimethylsiloxane | 100 g | 4 |
| 3c | | | | 200 g | 3 |
| 4 | B300 | Cross Oil | naphthenic oil | 20 g | 5 |
| 5 | L500 | Cross Oil | naphthenic oil | 100 g | 5 |
| 6a | SF96-50, PDMS | Momentive | silicone fluid | 20 g | 5 |
| 6b | | Performance | | 100 g | 3 |
| 7 | Plus 70T | STE Oil | mineral oil | 20 g | 5 |
| 8 | A-174 | Momentive | silane | 20 g | 5 |
| | | Performance | | | |
| 9 | Acetic acid | generic | white vinegar | 100 g | 5 |
| 10 | Niax* L5150 | Momentive | siloxane | 100 g | 4 |
| | | Performance | copolymer | | |
| 11 | Silbyk-TP3806 | BYK Chemie | polysiloxane | 100 g | 5 |
| 12 | Pel-Sil 9920 | Pelron | silicon based | 100 g of an | 4 |
| | | | surfactant | emulsion | |
| 13 | Pelron-9567 | Pelron | silicon based | 100 g of an | 5 |
| | | | surfactant | emulsion | |
| 14 | Thompson's | Thompson | hydrocarbon | 50 g | 5 |
| | WaterSeal | | | | |
| 15 | Concrete Sealer | Thorworks | acrylic water | 50 g of an | 5 |
| | | | base | emulsion | |
| 16 | Olympic | PPG | acrylic, lubricant, | 50 g of an | 5 |
| | WaterGuard | | polysiloxane, | emulsion | |
| | | | ethylene glycol | | |
| 17 | Clear | Sunnyside | clear silicon | 50 g of an | 5 |
| | Waterproofer | | | emulsion | |
| 18 | Ultra Gloss | Thorworks | 100% acrylic | 50 g of an | 4 |
| | Sealer for stone | | formula | emulsion | |
| | & aggregate | | | | |
| 19 | Z70 | DowCorning | emulsion of | 10 g of | 4 |
| | | | hydroxy | concentrate in | |
| | | | functional PDMS | 50 g aqueous | |
| | | | | solution | |
| 20 | HE 328 | Evonik | emulsion based | 10 g in 50 g | 4 |
| | | | on reactive | aqueous | |
| | | | organo-modified | solution | |
| | | | siloxanes | | |
| 21 | I-6184 | DowCorning | self-crossing, | 5.5 g in 50 g | 4 |
| | | | water-soluble | aqueous | |
| | | | siloxane | solution | |
| 22 | IE6694 | DowCorning | silicone emulsion | 4.2 g in 50 g | 3 |
| | | | | aqueous | |
| | | | | solution | |
| 23 | 6707W | DowCorning | water based | 8.3 g in in 50 g | 3 |
| | | | fluorosilane sol | aqueous | |
| | | | gel | solution | |
| 24 | SRC-220 | 3M | fluorinated | 13.3 g in 50 g | 3 |
| | | | polyurethane | aqueous | |
| | | | dispersion | solution | |
| 25 | SRC-220 | 3M | aqueous | 50 g | ≧3 |
| | Prototype | | fluoropolymer | | |
| | | | solution | | |
| 26 | IE 6683 | DowCorning | silicone emulsion | 6.3 in 50 g | ≧3 |
| | | | | aqueous | |
| | | | | solution | |
| 27 | ST-300 | Du Pont | partially | 10 g in 50 g | 1 |
| | | | fluorinated | aqueous | |
| | | | alcohol, reaction | solution | |
| | | | products with | | |
| | | | (P₂O₅), | | |
| | | | ammonium salts | | |
| 28 | ST-100 | Du Pont | Perfluoroalkyl | 5 g of | 3 |
| | | | methacrylate | concentrate in | |
| | | | copolymer | 50 g aqueous | |
| | | | | solution | |

In general, those samples where the stain resistance ranking was 4 or 5 were determined to be unusable. In other words, the treatment offered very little stain resistance. It goes without saying that where the granules were untreated, the stain resistance ranking was 5. The table also shows that those treatments that did not include a fluorine-containing compound required significant loading of the treatment material even to achieve marginal results (see, for example, samples 3C and 6B). Table 1 shows that Capstone ST-300 (DuPont) provided preferred stain resistance.

Various modifications and alterations that do not depart from the scope and spirit of this invention will become apparent to those skilled in the art. This invention is not to be duly limited to the illustrative embodiments set forth herein.

What is claimed is:

1. A method for preparing a bituminous roofing article, the method comprising:
(i) creating an asphaltic substrate by coating a reinforcing fabric with an asphaltic-based composition;
(ii) applying a fluorine-containing compound to a plurality of granules;
(iii) applying a silicone oil to the plurality of granules;
(iv) heating the plurality of granules;
(v) heating the asphaltic substrate; and
(vi) depositing the plurality of granules on the asphaltic substrate.

2. The method of claim 1, wherein the fluorine-containing compound is defined by the formula (I) or (II): 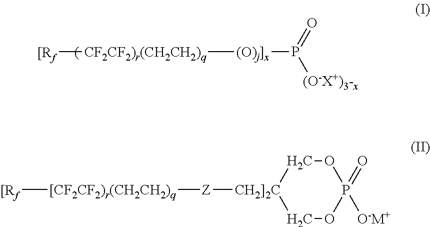
wherein r and q are independently integers of 1 to 3; R_{f} is linear or branched chain perfluoroalkyl group having 1 to 6 carbon atoms; j is an integer 0 or 1, or a mixture thereof, x is 1 or 2, Z is —O— or —S—, X is hydrogen or M, and M is an ammonium ion, an alkali metal ion, or an alkanolammonium ion.

3. The method of claim 1, wherein the fluorine-containing compound is defined by the formula (III) or (IV): 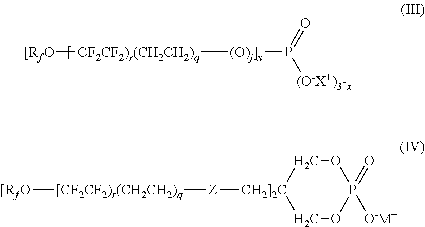
wherein r and q are independently integers of 1 to 3; R_{f} is linear or branched chain perfluoroalkyl group having 1 to 6 carbon atoms; j is an integer 0 or 1, or a mixture thereof, x is 1 or 2, Z is —O— or —S—, X is hydrogen or M, and M is an ammonium ion, an alkali metal ion, or an alkanolammonium ion.

4. The method of claim 1, wherein the fluorine-containing compound is defined by the formula (V) or (VI): 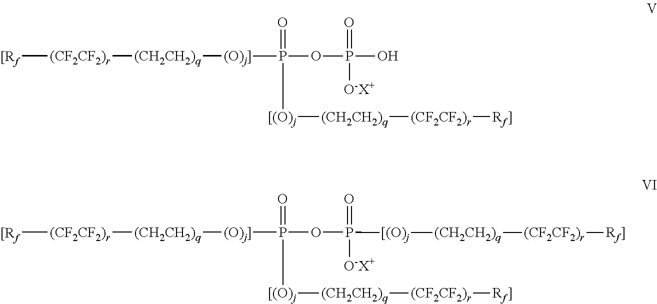
wherein r and q are independently integers of 1 to 3; R_{f} is linear or branched chain perfluoroalkyl group having 1 to 6 carbon atoms; j is an integer 0 or 1, or a mixture thereof, x is 1 or 2, X is hydrogen or M, and M is an ammonium ion, an alkali metal ion, or an alkanolammonium ion.

5. The method of claim 1, where the fluorine-containing compound is a surfactant having a molecular weight of less than 5000 g/mole.

6. The method of claim 1, further comprising the step of dehydrating the granules to include less than 5 wt % water.

7. The method of claim 1, where said step of applying a fluorine-containing compound to the plurality of granules includes applying an aqueous dispersion including at least 1 wt % of the fluorine-containing compound and at least 10 parts by weight of the dispersion is applied per 1000 parts by weight of the granules.

8. The method of claim 1, where the method includes applying the silicone oil to the surface of the granules prior to the step of applying a fluorine-containing compound.

9. The method of claim 1, where the method includes applying the silicone oil to the surface of the granules simultaneously with the step of applying a fluorine-containing compound.

10. The method of claim 1, where the method includes applying the silicone oil together with a carrier.

11. The method of claim 10, where the carrier is selected from the group comprising of a solvent, water, and a hydrocarbon oil.

12. The method of claim 1, where the silicone oil includes pendant hydrocarbyl groups such as alkyl and aryl groups.

13. The method of claim 1, where the silicone includes pendant functional groups, wherein the pendant functional groups include organic groups including one or more heteroatoms such as oxygen or nitrogen.

14. The method of claim 13, where the functional groups include alkoxy groups, epoxide groups, amine groups, and carboxyl groups.

15. The method of claim 1, where the silicone oil includes a methylthoxy polysiloxane.

16. The method of claim 1, where the granules carry at least 0.002% and less than 3% of silicone oil on a solid weight basis.

17. The method of claim 1, where the plurality of granules is selected from the group consisting of: ceramic, aluminosilicates, or calcined kaolin.

18. The method of claim 17, where the plurality of granules is calcined kaolin, where the calcined kaolin is thermally prepared at a calcination temperature of at least about 1000° C. and less than about 1300° C.

19. A method for preparing a bituminous roofing article, the method comprising:
(i) applying a fluorine-containing compound to a plurality of granules;
(ii) depositing the plurality of granules on an asphaltic substrate; where the fluorine-containing compound is defined by the formula (V) or (VI): 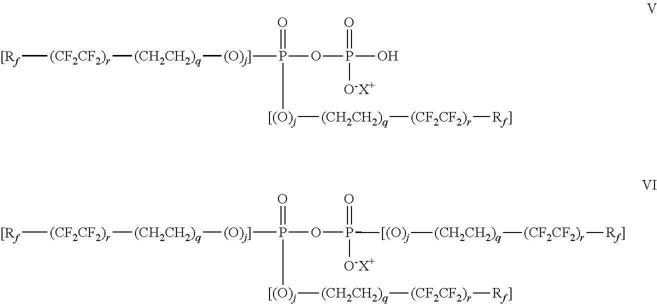
wherein r and q are independently integers of 1 to 3; R_{f} is linear or branched chain perfluoroalkyl group having 1 to 6 carbon atoms; j is an integer 0 or 1, or a mixture thereof, x is 1 or 2, X is hydrogen or M, and M is an ammonium ion, an alkali metal ion, or an alkanolammonium ion; and
(iii) applying a silicone oil to the surface of the granules.

20. A roofing article comprising:
a bituminous substrate and reflective granules deposited on the substrate, where the granules include a fluorine-containing compound applied to the surface of the granules,
where the fluorine-containing compound is defined by the formula (V) or (VI): 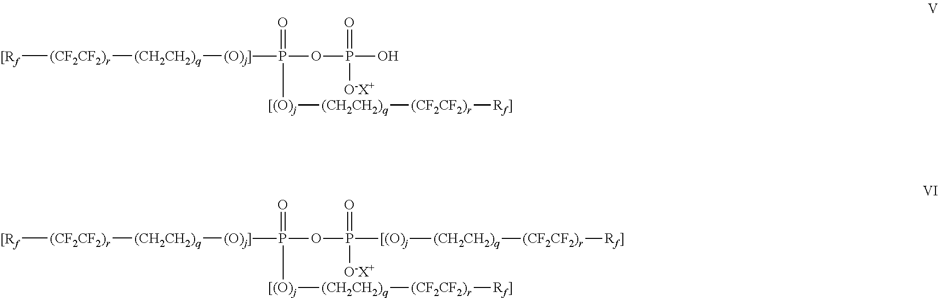
wherein r and q are independently integers of 1 to 3; R_{f} is linear or branched chain perfluoroalkyl group having 1 to 6 carbon atoms; j is an integer 0 or 1, or a mixture thereof, x is 1 or 2, X is hydrogen or M, and M is an ammonium ion, an alkali metal ion, or an alkanolammonium ion, and where the granules further include a silicone oil applied to the surface of the granules.
